(19) United States
(12) Patent Application Publication
(10) Pub. No.: US 2004/0164472 A1
(43) Pub. Date: Aug. 26, 2004

(54) Torsion or spiral spring made of single rods

(76) Inventor: Vladimir Kobelev, Attendorn (DE)

Correspondence Address: Robert P. Renke, Suite 250, 28333 Telegraph Road, Southfield, MI, 48034, US

(21) Appl. No.: 10/726,165

(22) Filed: Dec. 2, 2003

(30) Foreign Application Priority Data
Dec. 2, 2002 (DE) 102 56 402.7-12

(51) Int. Cl. F16F 1/18

(52) U.S. Cl. 267/160

(57) ABSTRACT

A spring with constant cross-sectional area for torsion and/or flexional strain is provided which includes a plurality of individual rods with a round or polygonal cross-section substantially identical to one another and unchanging over their length. In each case, the rods have line or surface contact with other rods and form a bundle held together at least at the ends of the rods. The rods can be round, hexagonal or isosceles triangular in cross-section, and the number of rods is 3n or 3n+1, whereby n is a natural number greater than or equal to 3. Alternatively, the rods can be octagonal or square in cross-section and the number of rods is 4n or 4n+1, whereby n is a natural number greater than or equal to 2.

### BACKGROUND OF THE INVENTION

The present invention relates to a spring with uniform cross-sectional area for torsion and/or flexional strain. The spring is particularly suited for applications in the area of engine and vehicle technology.

### BACKGROUND OF THE INVENTION

Compared to shackle springs or spiral springs, torsion bar springs have an extraordinarily high torsional strength relative to the material used. This may not be favorable in all applications. To be able to absorb large spring forces for given maximum tensions, considerable torsion spring lengths are required. This is often restricted by the installation ratios, and may also be limited by the kink limit, which must be taken into consideration with torsion springs.

Layered torsion bar springs for larger angles of rotation at any given moment are disclosed, for example, in Calculation and Shaping Metal Springs, Siegfried Gross, Springer-Verlag 1960. They comprise a bundle of flat bars of identical length, width and height, in which the ends of the bundles are clamped in heads, the recess of which corresponds to the cross-section of the bundles. Japanese patent publication 02236032 A discloses a torsion bar spring, in which individual round rods are clamped parallel to, and at a distance to one another in heads, which can be twisted against one another. Memory alloys are used for the rods, and these can be deformed plastically under torsion and recover and reshape with subsequent warming.

DE 39 12 944 A1 discloses a belt-tensioning device, in which a torsion spring made up of individual torsion bars between a fixing point and a clamping lever is effective for a tightening roller. The bars are composed of three hexagonal rods or four square rods. The torsion bars are arranged in a guide pipe in order to prevent flexion of the torsion bars under strain, and to prevent a change in the friction values on the contact surfaces between the individual torsion bars.

DE 1 856 795 U1 discloses a torsion rod bundle including, in particular, four round single rods, where the ends form a common polygonal clamping head. The individual rods are connected in the vicinity of the clamping heads with brazing solder.

U.S. Pat. No. 2,778,626 discloses a torsion spring arrangement, in which a group of six annularly arranged individual springs with hexagonal cross-section is clamped at the ends in bearings, which are mounted rotatably relative to one another.

### SUMMARY OF THE INVENTION

The present invention provides springs made up of a bundle of individual rods, which can easily be adapted to different applications and which, compared to known springs, have novel and extensively freely influenceable damping properties. A spring with constant cross-sectional area for torsion and/or flexional strain is provided which includes a plurality of individual rods with a round or polygonal cross-section substantially identical to one another and unchanging over their length. In each case, the rods have line or surface contact with other rods and form a bundle held together at least at the ends of the rods. The rods can be round, hexagonal or isosceles triangular in cross-section, and the number of rods is 3n or 3n+1, whereby n is a natural number greater than or equal to 3. Alternatively, the rods can be octagonal or square in cross-section and the number of rods is 4n or 4n+1, whereby n is a natural number greater than or equal to 2.

In particular, in springs having the number of rods equal to 3n or 4n, several rods converge in the center of the rod bundles. In springs having the number of rods equal to 3n+1 or 4n+1, a central single rod lies in the center of the rod bundles.

By using single elements identical to one another, which are held in terminal elements, whereby the single elements are in greater or the greatest possible packing density, a plurality of contact lines or contact surfaces forms between the individual rods, resulting in considerable friction effects when the springs deform, such as occurs under torsion. The springs thus have a strong damping characteristic.

Using identical single elements also enables them to be adapted to a wide range of applications in that, on the one hand, when using identical terminal elements, rods of varying length can be utilised, if ratios either require or allow this. On the other hand, the installation of springs with a different number of rods makes it much easier to create exchangeable, essentially structurally identical springs with a different spring rate. It is thus possible, for example, to selectively use place holder elements, which fill out the recess and enlarge it to the spring bundle and replace genuine torsion rods, in terminal elements with fixed preset take-up cross-section. At the same time, the externally employed placeholder elements can serve to wedge the rods in the recess in one of the terminal elements.

Usually the middle line of the spring body will be straight and will coincide with the longitudinal axis of the spring. In this context, the term ‘spring body’ means the spring, with exception of the terminal parts, as a whole and is thus, in most cases, synonymous with the term ‘rod bundles’.

The individual rods can have a round cross-section. Thus, they can be cut into lengths of drawn wire, whereby subsequent surface treatment with respect to good surface quality can be omitted. The individual rods can however also be polygonal in cross-section, whereby surface contact between the individual rods can be made instead of linear contact between the individual rods. This has considerable influence on the friction between the elements and thus on the damping of the spring as a whole. Also, such rods can be manufactured from drawn wire.

The bundle of rods as a whole has for its part a preferably substantially round or substantially symmetrical, in particular polygonal, cross-section.

The present invention thus provides a novel type of spring which can be varied in multiple ways and which can lead to novel applications of such springs. Examples for applications of the present spring are valve springs in internal combustion engines, springs or stabilisers in the running gear area and closing springs for doors or vehicle engine bonnets.

Other advantages and features of the invention will also become apparent upon reading the following detailed description and appended claims, and upon reference to the accompanying drawings.

### BRIEF DESCRIPTION OF THE DRAWINGS

For a more complete understanding of this invention, reference should now be made to the embodiments illustrated in greater detail in the accompanying drawings and described below by way of examples of the invention, wherein:

FIG. 1 shows a spring according to one embodiment of the present invention with parallel rods.

FIG. 2 shows a spring according to FIG. 1 with terminal elements:

A) in a perspective view; and

B) in an enlarged detail.

FIG. 3 shows different spring cross-sections of a bundle of round rods in cross-section:

A) in cross-section in hexagonal arrangement;

B) in cross-section in truncated triangular arrangement;

C) in cross-section in triangular arrangement; and

D) in cross-section in truncated hexagonal arrangement.

FIG. 4 shows different spring cross-sections with a bundle of hexagonal rods:

A) in cross-section in hexagonal arrangement;

B) in cross-section in truncated triangular arrangement;

C) in cross-section in triangular arrangement; and

D) in cross-section in truncated hexagonal arrangement.

FIG. 5 shows different spring cross-sections of a bundle of rods:

A) in an arrangement square in cross-section of rods with square cross-section;

B) in an arrangement square in cross-section of rods with round cross-section;

C) in an arrangement hexagonal in cross-section of rods triangular in cross-section;

D) in an arrangement truncated triangular in cross-section of rods triangular in cross-section;

E) in an arrangement square in cross-section of rods octagonal in cross-section; and

F) in an arrangement square in cross-section of rods octagonal in cross-section with intermediate elements.

### DETAILED DESCRIPTION OF THE DRAWINGS

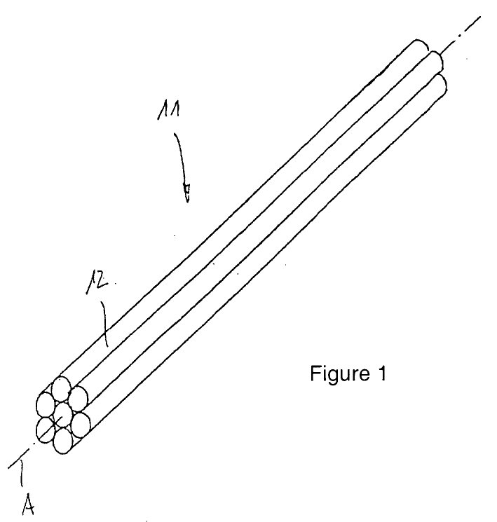

FIG. 1 illustrates a torsion bar spring 11 according to one embodiment of the present invention, having seven individual rods 12, which are superposed in the greatest possible packing density with surface contact. The longitudinal axis A of the spring 11 is at the same time the geometric middle line of the spring body or bundle of rods comprising the rods 12. A spring of the type shown here is preferably used as torsion bar spring; however, its use also or at the same time as spiral spring is not excluded. With each shape change for the spring body, surface friction occurs between the individual rods 12, so that additional damping occurs as a result of surface friction for inner damping in the spring steel.

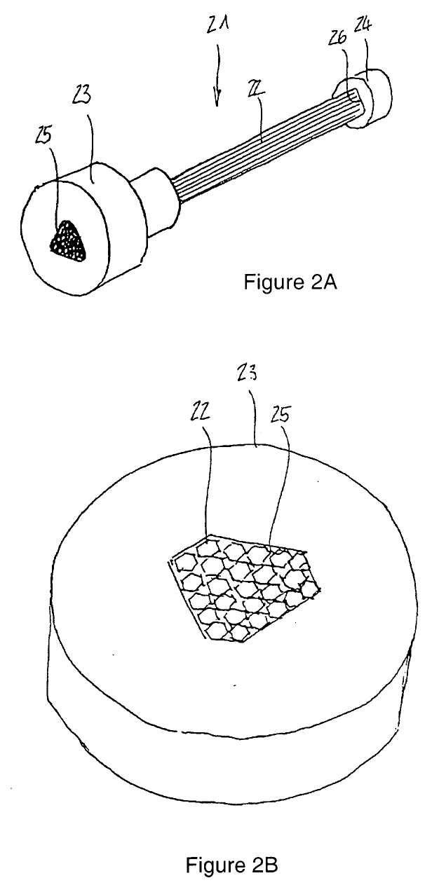

FIG. 2 illustrates a spring 21, assembled from a bundle of individual rods 22, with two terminal pieces 23, 24. The terminal pieces 23, 24 have central openings as recesses 25, 26, into which the bundle of spring rods 22 is inserted. In this case the individual rods 22 can be welded together, for example, at one end and inserted into the opening 26 in the terminal element 24, thus preventing any axial movement between the rods 22. At the other end, the rods 22 can be moved slightly axially towards each other in the opening 25 and relative to the terminal piece 23 because they are merely clamped into the terminal piece 23. Of course, both of the ends can remain free as both can be welded depending upon the relative axial play desired between the rods 22.

As is clearer in FIG. 2B, the individual rods 22 are in this case hexagonal in cross-section and the opening 25 is truncated triangular in cross-section. This represents the greatest possible packing density of the rods 22; the gaps between the individual rods shown here are exaggerated and are illustrated for clarification purposes only.

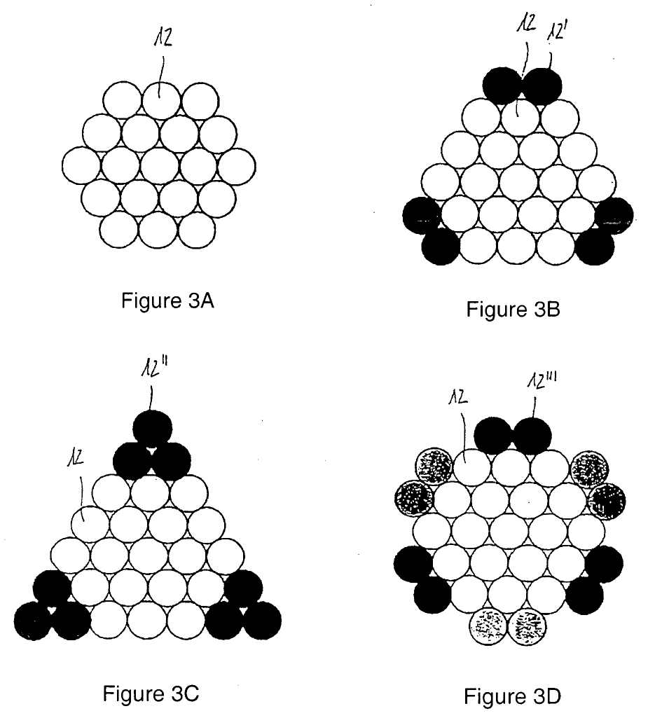

FIG. 3 shows cross-sections through rod bundles of rods in round cross-section, which are arranged in the greatest possible packing density on a given basic shape.

In FIG. 3A, nineteen round rods 12 are arranged in a hexagonal cross-section.

In FIG. 3B, the nineteen rods 12 are complemented in the arrangement according to FIG. 3A by six dark-shaded rods 12″ and hereby form a triangle with truncated corners.

In FIG. 3C, the nineteen rods 12 are complemented in the arrangement according to FIG. 3A by nine rods, or the twenty-five rods in the arrangement according to FIG. 3B are complemented by three additional rods 12″, so that they form a bundle of 28 rods on a triangular base surface.

In FIG. 3D, the nineteen rods are complemented in the arrangement according to FIG. 3A by twelve rods 12′″, so that in cross-section they form a hexagon with truncated corners. The total number of rods here is 31. In each of FIGS. 3B-3D, the complementary rods 12′, 12″, 12′″ can be the same or different than the primary torsion rods 12. In this regard, the complementary rods 12′, 12″, 12′″ can act as place holder rods to improve or alter the fixation of the primary rod bundle in the terminal elements. The complementary rods 12′, 12″, 12′″ can also modify the spring characteristic of the resulting spring bundle.

In each of the embodiments, the exterior surface of each of the plurality of rods comprising the rod bundle can be polished or coated to reduce the friction along the line or contact surface area between the rods. Where complementary rods are also used, they can likewise be polished or coated to reduce axial friction or, alternatively, scored or untreated to increase axial movement resistance.

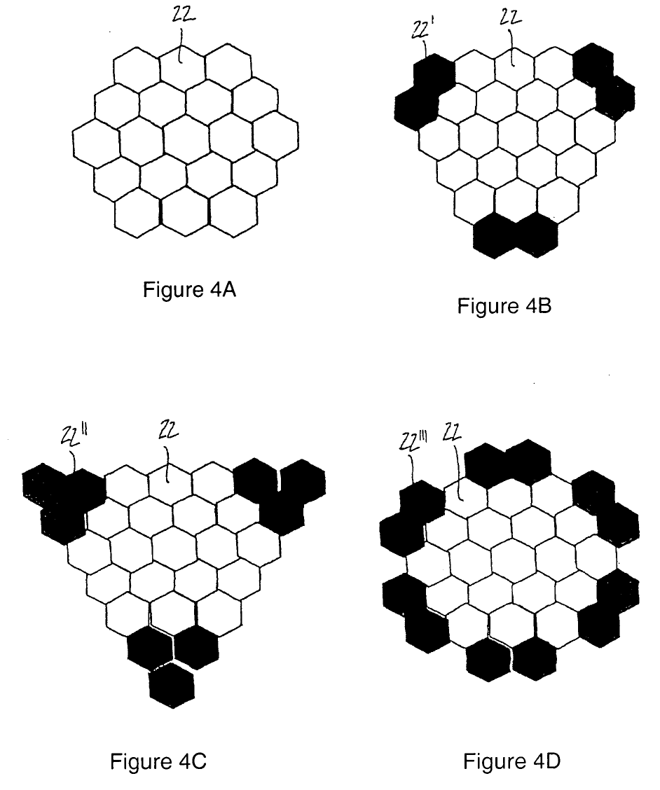

FIG. 4 shows cross-sections through rod bundles of rods hexagonal in cross-section, which are arranged in the greatest possible packing density on a given base form. In FIG. 4A, nineteen rods 22 are arranged in a hexagonal cross-section. In FIG. 4B, the nineteen rods 22 are complemented in the arrangement according to FIG. 4A by six dark-shaded rods 22′ and form a triangle with truncated corners. In FIG. 4C, the nineteen rods 22 are complemented in the arrangement according to FIG. 4A by nine rods, or the twenty-five rods in the arrangement according to FIG. 2B are complemented by three additional rods 22″, so that they form a bundle of 28 rods on a triangular base surface. In FIG. 4D, the nineteen rods are complemented in the arrangement according to FIG. 4A by twelve rods 22′″, so that in cross-section they form a hexagon with truncated corners. The total number of rods is 31. Again, in each of FIGS. 4B-4D, the complementary rods 22′, 22″, 22′″ can be the same or different than the primary rods 22 and can alter the fixation of the rod bundle in the terminal element and/or modify the characteristics of the resulting spring bundle.

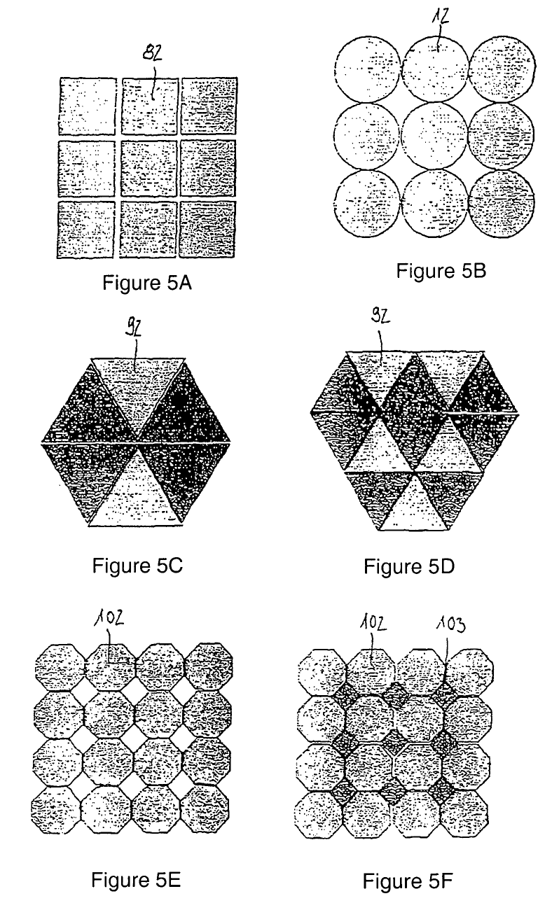

In FIG. 5 various other cross-sections are shown for springs with other forms of rod cross-sections according to embodiments of the present invention: FIG. 5A shows a square arrangement of nine rods 82 square in cross-section. FIG. 5B shows a square arrangement of nine rods 12 round in cross-section. FIG. 5C illustrates a hexagonal arrangement of six rods 92 with triangular cross-section. FIG. 5D shows a triangular arrangement with truncated tips of thirteen rods 92 with triangular cross-section. In FIG. 5E, a square arrangement of sixteen rods 102 with octagonal cross-section is shown. FIG. 5F includes the arrangement of sixteen rods 102 with octagonal cross-section according to FIG. 5E, whereby nine fill bodies 103 are employed. These interstitial elements 103 may comprise material identical to or different than rods 102, such as a damping mass, which can be optionally vulcanized onto the free non-adjacent surfaces of the rods 102 to form a matrix body. Such an arrangement permits movement of the individual rods 102 against one another, and increases the damping of the resulting spring bundle.

From the foregoing, it can be seen that a new and improved spring assembly ahs been provided having easily modified damping properties. Each spring assembly has a constant cross-section comprising a plurality of individual rods with round or polygonal cross-section. Each individual rod within the bundle is substantially identical to each other rod, and is unchanging in cross-section along its length. In each case, the individual rods have line or surface contact with adjacent rods. With round, hexagonal or triangular cross-section rods, the bundle comprises 3n or 3n+1 rods wherein n is a natural number greater than or equal to 3. With octagonal or square cross-section rods, the bundle comprises 4n or 4n+1 rods wherein n is a natural number greater than or equal to 2.

While the invention has been described in connection with several embodiments, it should be understood that the invention is not limited to those embodiments. Rather, the invention covers all alternatives, modifications, and equivalents as may be included in the spirit and scope of the appended claims.

What is claimed is:

1. A torsion or flexion spring assembly having a uniform cross-sectional area comprising a plurality of individual rods each with a substantially identical cross-section unchanging along its length, and each having line or surface contact with at least two other rods, the plurality of rods forming at least a rod bundle held together at the ends, wherein each of the plurality of rods is round, hexagonal or isosceles triangular in cross-section and wherein the number of rods is 3n or 3n+1, whereby n is a natural number greater than or equal to 3.

2. A torsion or flexion spring assembly having a uniform cross-sectional area comprising a plurality of individual rods each with a substantially identical cross-section unchanging along its length, and each having line or surface contact with at least two other rods, the plurality of rods forming at least a rod bundle held together at the ends, wherein each of the plurality of rods is octagonal or square in cross-section and wherein the number of rods is 4n or 4n+1, whereby n is a natural number greater than or equal to 2.

3. The spring assembly of claim 1 wherein several rods converge with a number of rods equal to 3n in the center of the rod bundle.

4. The spring assembly of claim 2 wherein several rods converge with a number of rods equal to 4n in the center of the rod bundle.

5. The spring assembly of claim 1 wherein a central single rod lies in the center of the rod bundle when the number of rods is 3n+1.

6. The spring assembly of claim 2 wherein a central single rod lies in the center of the rod bundle when the number of rods is 4n+1.

7. The spring assembly of claim 1 wherein the rod bundle is substantially round in cross-section.

8. The spring assembly of claim 2 wherein the rod bundle is substantially round in cross-section.

9. The spring assembly of claim 1 wherein the rod bundle is substantially central-symmetrical in cross-section.

10. The spring assembly of claim 2 wherein the rod bundle is substantially central-symmetrical in cross-section.

11. The spring assembly of claim 1 wherein the number of rods is 19, 25, 28 or 31, and the rods are round or hexagonal in cross-section.

12. The spring assembly of claim 2 wherein the number of rods is 9 or 16 and the rods are square or octagonal in cross-section.

13. The spring assembly of claim 1 wherein the surfaces of each of the rods are polished or are provided with a low-friction coating.

14. The spring assembly of claim 2 wherein the surfaces of each of the rods are polished or are provided with a low-friction coating.

15. The spring assembly of claim 1 wherein the rods of a rod bundle are cast in a matrix body, which permits movement of the individual rods against one another in the matrix body.

16. The spring assembly of claim 2 wherein the rods of a rod bundle are cast in a matrix body, which permits movement of the individual rods against one another in the matrix body.

17. The spring assembly of claim 1 wherein the rods are held at each end of the spring assembly in a clamping of constant cross-section.

18. The spring assembly of claim 2 wherein the rods are held at each end of the spring assembly in a clamping of constant cross-section.

19. The spring assembly of claim 1 wherein the rods are fixed axially against one another at one end and, at the other end, can be moved axially with respect to one another.

20. The spring assembly of claim 2 wherein the rods are fixed axially against one another at one end and, at the other end, can be moved axially with respect to one another.

21. The spring assembly of claim 17 wherein the rods can be moved axially with respect to one another at both ends inside the respective clamping.

22. The spring assembly of claim 18 wherein the rods can be moved axially with respect to one another at both ends inside the respective clamping.
